(19) United States
(12) Patent Application Publication
(10) Pub. No.: US 2004/0243922 A1
(43) Pub. Date: Dec. 2, 2004

(54) Method and process for scheduling and producing a network event

(76) Inventors: Peter Sirota, Seattle, WA (US); Don Johnson, Seattle, WA (US); Sudheer Tumuluru, Bellevue, WA (US)

Correspondence Address: FISH & RICHARDSON PC, 225 FRANKLIN ST, BOSTON, MA, 02110, US

(21) Appl. No.: 10/449,863

(22) Filed: May 30, 2003

(51) Int. Cl. G06F 17/00

(52) U.S. Cl. 715/500; 709/200

(57) ABSTRACT

Method and apparatus, including computer program products, for scheduling a user-defined event for transmission over a network includes receiving event scheduling data over the network from a user, receiving event content data over the network from the user, producing a file that includes data based on the event scheduling data and the event content data, and storing the file on a storage device for retrieval based on the event scheduling data.

### BACKGROUND

This application relates to scheduling and producing a network event.

Events such as a university course lectures, stockholder meetings, business meetings, musical concerts, and other similar events are capable of being broadcast to interested viewers and in some instants recorded for later viewing. To view these events, the events are broadcast over a communication system such as a cable television system, radio system, of other similar communication system such as the Internet. By broadcasting an event over the Internet, the event may be viewed on one or more computer systems executing a web browser process (e.g., Microsoft Explorer™, Netscape Navigator™, etc.) or other process (e.g. RealNetworks Video Player™, QuickTime™ Video Player, etc.) capable of displaying the transmitted content. Content such as video, audio, and data can also be merged into a complex multimedia event for broadcasting over the Internet and viewed by a targeted audience at a particular time and date. Due to the complexities of merging content into multimedia events, event originators (e.g., universities, corporations, etc.) typically employ one or more businesses to collect the event content, merge the content into a multimedia event, and broadcast the event to the target audience for viewing and interaction at the scheduled time and date.

### SUMMARY

According to an aspect of this invention, a method of scheduling a user-defined event for transmission over a network includes receiving event scheduling data over the network from a user, receiving event content data over the network from the user, producing a file that includes data based on the event scheduling data and the event content data, and storing the file on a storage device for retrieval based on the event scheduling data.

One or more of the following advantages may be provided from the invention.

By providing a system for producing and scheduling events to a user such as an event originator (e.g., a university, corporation, etc.), multimedia events can be produced and scheduled for broadcasting over the Internet without contracting or employing additional personnel. By providing users the capability for producing and scheduling events, the cost associated with the events is reduced. Further, by not contracting or employing additional personnel, the probability of an event production error or scheduling error is reduced since fewer personnel are involved. Additionally, since the user controls the complexity of the multimedia event, the user determines the level of effort applied to produce the event based on, for example, the amount of time before the scheduled date of the event, budgetary concerns, the targeted audience, and other similar factors. By allowing the user, such as a business entity with a relatively small operating budget, multimedia events can be inexpensively produced and scheduled such that the user controls the event content along with content arrangement and scheduling of the event (e.g., a series of course lectures, a stockholder meetings, public announcements, business meeting, or other similar event) associated with the user.

Other features will be apparent from the following description, including the drawings, and the claims.

### DESCRIPTION OF DRAWINGS

FIG. 1 is a block diagram depicting a communication network for producing and scheduling events.

FIG. 2A-B are diagrams pictorially depicting user interfaces for producing and scheduling an event.

FIG. 3 is a diagram pictorially depicting a user interface broadcasting an event.

FIG. 4 is a flow diagram of a content scheduling process.

FIG. 5 is a flow diagram of an event launching process.

### DETAILED DESCRIPTION

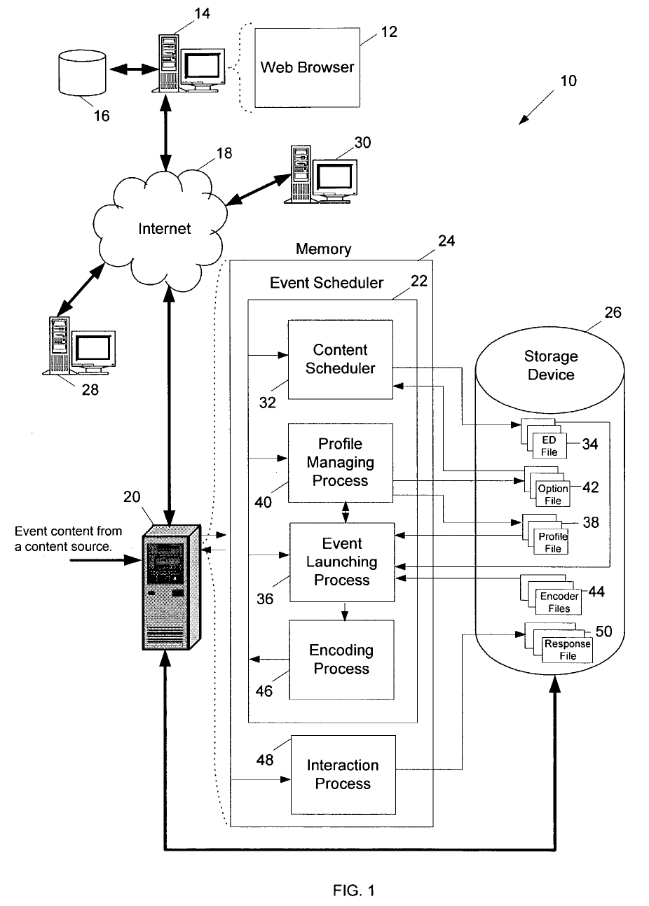

Referring to FIG. 1, a communication network 10 includes a web browser 12 (e.g., Microsoft Explorer™, Netscape Navigator™, etc.) that is executed by a computer system 14 (via processor and memory not shown) and is stored on a storage device 16 (e.g., hard drive, CD-ROM, etc.) that is in communication with the computer system. The computer system 14 is also in communication through the Internet 18, or other similar communication system (e.g., a local area network, a wide area network, an intranet, etc.), to a server 20 that executes an event scheduler 22 resident in memory 24 (e.g., random access memory, read only memory, etc.) of the server and stored on a storage device 26 (e.g., hard drive, CD-ROM, etc.) that is in communication with the server. However, in some arrangements the functionality of the server 20 is distributed across two or more servers or other similar digital devices. In general, the web browser 12 provides a user (e.g., an event originator such as a corporation, university, etc.) the capability of accessing the event scheduler 22 to produce and schedule one or more events capable of being broadcast over the communication network 10 for viewing by event attendees on computer systems 28, 30 also in communication with the Internet 18.

By using the event scheduler 22 the user can produce and schedule events through the Internet 18 without employing or contracting one or more event developers (e.g., a web event development business) to produce and schedule the broadcast of the event. Additionally, by accessing the event scheduler 22 executed on the server 20 through the Internet 18, the user does not incur additional expenses for purchasing equipment (e.g., server hardware, software, etc.) to independently produce and schedule complex multimedia events. Additionally, since the event scheduler 22 is remotely executed and stored on the server 20, personnel associated with the server, but not the user of computer system 14, monitor and maintain the event scheduler along with the server and other associated equipment (e.g., storage device 26). Further, after an event is produced and scheduled, the event scheduler 22 monitors the current time and date so that the event is appropriately broadcast to the computer systems 28, 30 without further input from the user. Additionally, by remotely storing data associated with the event on storage device 26, or other similar storage device, storage space is conserved on the storage device 16 local to the computer system 14.

In general, for the user to produce and schedule an event, the event scheduler 22 transmits potential event content and associated setting options from the server 20 to the computer system 14 for displaying on the web browser 12 and to provide the user the ability to select the type of content (e.g., video, audio, data, etc.), identify the particular source of the content (e.g., a video feed, audio tape, data file, etc.), and provide other input needed for producing and scheduling an event. For example, to produce one event the user selects to include video or audio content in the event along with including data such as textual data (e.g., a Microsoft Word™ document), digital graphics (e.g., a JPEG file), data presentations (e.g., a Microsoft PowerPoint™ presentation), or other data capable of being presented by the computer systems 28, 30.

Along with selecting the type of content to include in the event, the event scheduler 22 receives user input through the web browser process 12 that identifies the source of the selected content to be included in the event. For example, the user provides input data that identifies a location of a particular PowerPoint™ presentation on a storage device such as storage device 16, or identifies a particular satellite feed to supply video content during an event, or in another example identifies a particular phone line that provides an event's audio content, or other similar content source. In some arrangements the selectable content types along with the associated content sources are provided to the user by displaying one or more user interfaces on the web browser 12.

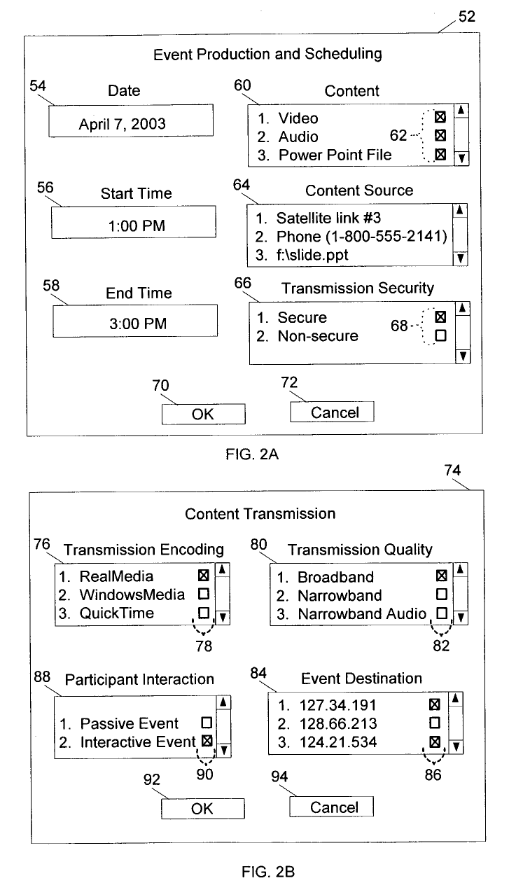

After the user has produced and scheduled the event by appropriately inputting data and selecting settings in an event scheduler user interface 52 (shown in FIG. 2A) and an content transmission user interface 74 (shown in FIG. 2B) as discussed below, the input data and selected settings are transmitted from the web browser 12 to the event scheduler 22. Once received by the event scheduler 22, the data and settings are transferred to a content scheduler 32 that enters the input data and selected settings in an event data (ED) file 34 that is stored on the storage device 26 until the time and date of the scheduled event arrives.

The event scheduler 22 also includes an event launching process 36 that determines if a scheduled time and date of the event associated with the ED file 34 has arrived. Typically, the event launching process 36 accesses the ED file 82 for scheduled date and time data stored in the file to determine if appropriate to execute the event. Alternatively, the event launching process 36 accesses a log file (not shown) or other similar data-storing file such as a database for monitoring the execution time and date of each scheduled event.

The ED file 34 also identifies a profile file 38 associated with the scheduled event. In this particular example, the profile file 38 is also stored on the storage device 26, however in some arrangements the profile file 38 is stored on another storage device not storing the ED file 34. In general, the profile file 38 is produced from a profile managing process 40 that is included in the event scheduler 22. The profile file 38 is typically an extensible markup language (XML) file and includes data associated with the transmission quality selected by the user in the transmission quality selection field 80 (shown in FIG. 2B). However, in some arrangements the ED file includes data associated with the transmission quality, or other similar data, so that the ED file does not need to identify a profile file.

The profile managing process 40 is used by event managing personnel typically located with the server 20 to produce and maintain the profile files 38 used by the event launching process 36. The profile managing process 40 also allows event managing personnel to assist the user in producing and scheduling an event by monitoring and maintaining the profile file 38 such that, for example, as different or improved transmission capabilities are implemented on the server 20 (e.g., adding a faster network interface card, etc.), event managing personnel produce and store a profile file capable of using the different or improved transmission capabilities.

The profile managing process 40 is also used by the event managing personnel to produce one or more option files 42 and to store the option files on the storage device 26 or other similar storage device in communication with the server 20. The option files 90 include data that represents the supported capabilities of the event scheduler 22 that a user selects from to produce and schedule an event.

The storage device 26 also stores one or more encoder files 44 that are used by the event launching process 36 to initiate a respective encoding process 46 associated with the encoding format selected by the user in the transmission encoding selection field 76 (shown in FIG. 2B). In general, the encoder file 44 includes instructions and data to execute the encoding process 46.

During a scheduled event a data stream, which includes the event content selected by the user, is transmitted from the server 20 to the computer systems (e.g., computer systems 28 and 30) selected to broadcast the event. However, in some arrangements prior to receiving the broadcast of the event, one or more of the event attendees are prompted to input data into the respective computer systems 28,30 for gaining access to view the event. The input data, for example, includes a password, a previously assigned registration number, or other data used for restricting access. Also, in some arrangements the event attendees are prompted to enter other types of data such as a mailing address, billing information, or other similar data that is transmitted to the server 20 for collection and further uses (e.g., sending to an event sponsor). In some arrangements, as the data stream is received and decoded, and the event included in the data stream is presented, interactive material (e.g., polling questions, survey questions, etc.) included in the event is also presented to the attendees. In response to the interactive material, the attendees input response data into the respective computer systems 28, 30 and the response data is sent to the server 20 and passed to an interaction process 48 executing in the memory 24 of the server. Also, in some arrangements the executing event is capable of receiving unsolicited feedback (e.g., questions, comments, etc.) from the attendees (e.g., students) for transmission to the content source (e.g., a teacher lecturing over a phone line) in real-time during the event. Besides being sent from the respective computer system 28, 30 to the server 20 and then to the content source, the unsolicited feedback is also sent to the interaction process 48. After the interaction process 48 receives the solicited or unsolicited feedback, the feedback is stored in a response file 50 on the storage device 26, or another similar storage device in communication with the server 20. By storing the responses of a particular event, statistical processes (not shown) can access the response files and process the stored responses for polling and survey results. Additionally, stored unsolicited feedback is capable of being post-processed to determine problematic areas of a lecture or to expose other similar event artifacts after the scheduled event.

Referring to FIG. 2A an exemplary embodiment of an event user interface 52 for producing and scheduling an event is shown. Typically the event user interface 52 is displayed to the user on the computer system 14 by using the web browser 12 (shown in FIG. 1). In this particular example, to produce and schedule an event, the user enters data into input fields included in the event user interface 52 and selects from data provided in selection fields. For example, a date input field 54 receives, as entered by the user, a particular date (e.g., Apr. 7, 2003) or dates to schedule an event for broadcasting. The event user interface 52 also includes a start time input field 56 and an end time input field 58 that respectively receive a starting time (e.g., 1:00 PM) and an ending time (e.g., 3:00 PM) for broadcasting the scheduled event on the date(s) provided in the date input field 54. However, in some examples, the end time input field 58 is replaced with an input field that receives a duration time (e.g., 2 hours) of the event or other similar scheme to define the time period of the scheduled event. The event user interface 52 also includes a content selection field 60 for the user to select the type of content to be included in the scheduled event. In this arrangement the user selects individually, or in combination, from video content, audio content, and content included in a data file (e.g., a Microsoft PowerPoint™ presentation) that includes text and graphics. To select one or more of the potential content types, the user enters a selection into one or more of three respective selection boxes 62 associated with the three content types provided in the content selection field 60. However, in some arrangements other selection techniques (e.g., highlighting, etc.) are provided to the user for selecting one or more of the content types. In this particular example, the user has selected all three content types. Once the user selects the type of content to be included in the scheduled event, the source of each selected content type is entered or selected by the user. For example, data identifying one or more video cameras as sources of real-time video content is entered. Or a particular digital versatile disc (DVD) or VHS tape are identified as sources of previously recorded video content along with other similar storage devices that store captured video content. Similarly, identified sources of audio content include, microphones, telephones, and other real-time audio content capturing devices. Also, previously recorded audio content is identified with sources such as magnetic audio tapes, digital audio tapes (DAT), compact discs (CD), or other similar audio content storage devices.

The event user interface 52 includes a content source input field 64 for the user to identify one or more sources of the content selected in the content selection field 60. In this example, the user enters data into the content source input field 64 to identify the source of each selected content type. In this particular example, the user enters satellite link data (i.e., satellite link #3) into the content source input field 64 to identify a live video feed that provides the selected video content for the scheduled event. However, in other scheduled events, the video content is supplied by other wireless links (e.g., radio frequency, infrared, laser, etc.), hardwire links (e.g., cable television systems), or a video content storage device (e.g., DVD, magnetic tape, etc.), or other similar video content source. Also, for this scheduled event, the source of the selected audio content is supplied over a phone line that is identified by a phone number (e.g., phone number 1-800-555-2141) in the content source input field 64. In some arrangements the identified phone number is used by the particular source (e.g., a lecturer calls to the telephone number to provide audio content) to place a telephone call for providing audio content. However, in other arrangements the identified telephone number is used by the communication system 10 to place a telephone call to the source (e.g., a lecturer, group meeting, etc.) for collecting the associated content. Also, in other scheduled events real-time audio content is supplied through other transmission paths (e.g., a satellite link, an Internet site, audio content from a television broadcast, etc.) or from previously recorded audio content (e.g., a CD, audio content of a DVD, magnetic audio tape, etc.). Additionally, in this example of a scheduled event, the user selected to include content of a PowerPoint™ presentation file, as shown in the content selection field 60. To access the particular presentation file to produce the scheduled event, the user enters the storage location of the file in the content source input field 64 (e.g., f:\slide.ppt). In other examples of scheduled events, the identified content sources include Internet sites, integrated services digital network (ISDN) links, file transfer protocol (FTP) site addresses, or other similar identifiers for locating content such as a particular data file.

The event user interface 52 also includes a security selection field 66 for the user to select whether or not the scheduled event is transmitted on a secure channel. By selecting to securely transmit the scheduled event, one or more security techniques are applied to the content prior to transmitting to one or both of the computer systems 28, 30 (shown in FIG. 1). For example, if a secure transmission is selected, one or more encryption techniques (e.g., public key, digital signature, etc.), or other similar security techniques are applied to a portion or all of the content included in the scheduled event. Alternatively, if the user selects a non-secure transmission, little or no security techniques are applied to the selected event content. In this particular example, the user selects to transmit the event in a secure mode by respectively selecting from a group of selection boxes 68 included in the security selection field 66. Once the user enters the appropriate data and makes appropriate selections, the user confirms the entries and selections by selecting a confirmation button 70 labeled “OK”. Alternatively, if the user selects a cancellation button 72 included in the event user interface 52, the data entries and entered selections are cancelled and not sent to the event scheduler 22 (shown in FIG. 1).

Referring to FIG. 2B, in some arrangements, one or more additional user interfaces are transmitted from the event scheduler 22 (FIG. 1) and displayed by the web browser 12 (FIG. 1) to the user. In this particular example a content transmission user interface 74 is presented after or simultaneously with the event user interface 52 for the user to produce the scheduled event. Additionally, in some arrangements data input fields and selection fields associated with the content transmission user interface 74 and the event user interface 52 are combined, interchanged, or represented on one or more other additional user interfaces. The content transmission user interface 74 presents selectable parameters associated with the transmission of the scheduled event that are supported by the server 20 (shown in FIG. 1). In particular, data entered and selections made by the user in the content transmission user interface 74 establish particular transmission parameters associated with transmitting the scheduled event from server 20 (shown in FIG. 1) to at least one or both of the computer systems 28, 30 (also shown in FIG. 1). For example, the content transmission user interface 74 includes selection fields for the user to select encoding formats, transmission quality, event attendee participation level, the particular presentation locations of the scheduled event, and other similar transmission parameters.

In this particular example, the content transmission user interface 74 includes four selection fields for the user to tailor the transmission of the scheduled event content. The content transmission user interface 74 includes a transmission encoding selection field 76 that provides the user a list of selectable encoding formats for encoding the event content prior to transmitting at the scheduled date and time entered into the event user interface 52. By encoding the transmission, one or more formats are applied to the event content (e.g., video, audio, data, etc.) for transmitting over the Internet 18 (shown in FIG. 1). For example, the transmission encoding selection field 76 includes selectable formats for encoding content into a RealMedia format (i.e., a combination of Real Video and Real Audio formats) from RealNetworks Inc. of Seattle, Wash., herein incorporated by reference. Additionally the transmission encoding selection field 76 includes a selection for encoding the event content into the WindowsMedia format from Microsoft Inc., of Redmond, Wash., and the QuickTime format from Apple Inc., of Cupertino, Calif., both of which are also herein incorporated by reference. Additionally, in some arrangements the transmission encoding selection field 76 includes other similar user-selectable formats such as MPEG-4 or other formats for encoding the scheduled event content for transmission. Typically encoding formats are selected that are supported by the destination computer systems used to present the events, such as computer systems 28 and 30. In this particular example, the user selects one or more of the encoding formats by respectively selecting from a group of selection boxes 78 included in the transmission encoding selection field 76. In this example, the user has selected to transmit the event content in the RealMedia™ format as indicated by the selection boxes 78.

The content transmission user interface 74 also includes a transmission quality selection field 80 that provides the user the capability to select one or more transmission modes to transmit the scheduled event. In general, each selectable transmission mode is associated with one or more transmission parameters that depend on the type of content included in the scheduled event. For example, one transmission mode included in the transmission quality selection field 80 is a broadband transmission mode that is typically selected by the user for transmitting events at relatively high data rates (e.g., 56K bits per second and higher) based on the transmission and reception capabilities of the server 20 and the computer systems 28, 30 presenting the event. In some arrangements the relatively higher transmission rates associated with the broadband transmission mode support transmitting video content capable of being viewed with a screen size of 320 by 240 pixels on the computer systems 28, 30. Additionally, in some arrangements the broadband transmission mode supports transmitting a combination of video content and data content (e.g., a PowerPoint™ presentation). By selecting the broadband transmission mode, other transmission parameters such as video frame rate, the particular video encoder used, and other similar parameters are identified.

In this example, the transmission quality selection field 80 also includes a narrowband transmission mode that is typically selected for transmitting content at relatively lower data rates (e.g., lower than 56K bits per second) based on the transmission and reception capabilities of the server 20 (shown in FIG. 1) and the computer systems 28, 30. Additionally, by selecting the narrowband transmission mode, video content included in the scheduled event is transmitted for viewing with a relatively smaller screen size, such as 176 pixels by 144 pixels or other similar screen size for viewing on the computer systems 28, 30. Further the narrowband transmission mode typically supports transmitting video content or data content (e.g., a PowerPoint™ presentation) individually or in combination. Similar to the broadband transmission mode, selection of the narrowband transmission mode sets transmission parameters such as the frame rate, the particular encoder used, and other parameters associated with narrowband transmission. In this example, the transmission quality selection field 80 also includes a selectable narrowband audio transmission mode that is typically selected for transmitting event content at relatively lower data rates (e.g., 28K bits per second or lower) based on the transmission and reception capabilities the sever 20 (shown in FIG. 1) and the destination computer systems 28, 30 (also shown in FIG. 1). Additionally the narrowband audio transmission mode is selected for scheduled events that include audio content or audio and data content (e.g., a PowerPoint™ presentation). Further, by selecting the narrowband audio transmission mode, transmission parameters such as the particular audio encoder being used is identified to the event scheduler 22 (shown in FIG. 1) by the user selecting this transmission mode. In this particular example the user has respectively selected the broadband transmission mode from a group selection boxes 82 that are associated with the three respective transmission modes and are included in the transmission quality selection field 80. By selecting the broadband transmission mode in the transmission quality selection field 80, transmission and reception parameters (e.g., video screen size, frame rate, etc.) are identified and sent to the event scheduler 22 (shown in FIG. 1). However, in some arrangements alternatively to defining and presenting transmission modes (e.g., broadband, narrowband, narrowband audio, etc.), the individual transmission and reception parameters (e.g., video screen size, frame rate, transmission rate, etc.) are individually presented in the content transmission user interface 74 so that the user can select or enter data to identify the parameters individually. Also, in some arrangements two or more of the transmission modes are selected for transmitting the scheduled event. Typically by selecting two or more transmission modes each of the computer systems 28, 30, or other similar event receiving sites, determine which of the two or more transmissions to select from for executing the event based on their respective equipment and capabilities.

The content transmission user interface 74 also includes an event destination selection field 84 that allows the user to select where the scheduled event is transmitted for presentation. In this particular example, potential destination computer systems are identified by Internet Protocol (IP) addresses. In some arrangements the IP addresses are distinct, however in other arrangements the IP addresses are included in a range of IP addresses (e.g., a sequence of IP addresses). In other arrangements, potential destination computer systems are identified by respective serial port identifiers, parallel port identifiers, bus addresses, or other similar indicators or designations. In this particular example the computer systems 28 and 30 (shown in FIG. 1) have respective IP addresses “127.34.191” and “124.21.534” and have been selected to receive the scheduled event, as indicated by respective selections made in a group of selection boxes 86, while another computer system (not shown) identified by the IP address “128.66.213” has not been selected for receiving the scheduled event. Also, in some arrangements, one or more of the potential destination computer systems are restricted from receiving a scheduled event based on the location (e.g., “geo-blocking”) of the respective computer system or based on another similar filtering scheme. Additionally, in some arrangements, prior to receiving and executing a scheduled event, particular data (e.g., a password, etc.) needs to be transmitted from one or more of the potential destination computer systems to the server 20 for allowing access to the scheduled event.

The content transmission user interface 74 also includes a participant interaction selection field 88 for the user to select whether the scheduled event is capable of interacting with one or more of the event attendees through the destination computer systems 28, 30. For example, if the scheduled event includes broadcasting an educational lecture capable of allowing interactions among students viewing the lecture on the computer systems 28 and 30 and the source of the lecture (e.g., a professor on a phone line), the user respectively selects from a group of selection boxes 90 for an interactive event. In some arrangements, by selecting an interactive event, the scheduled event provides questions to the event attendees to collect responses for use in polling activities, survey activities, and other data processing activities related to the scheduled event. Additionally, if the scheduled event is selected for interactive capabilities, in some arrangements additional user interfaces are displayed to the user for providing additional data such as a data file name and location that includes polling or survey questions and potential responses, or data identifying a particular communication link (e.g., phone line) for the attendees to provide questions and feedback, or other similar data for aiding event interactions. However, in some arrangements the scheduled event is produced for passive viewing on the computer systems 28, 30 and does not provide interactive capabilities for the event attendees. To produce a passive event, which typically reduces bandwidth needed to broadcast the event, the user respectively selects from the group of selection boxes 90. However, in some arrangements viewer input is accepted during passive viewing of a scheduled event so that the viewer is capable of commenting or provide data associated with the event. Also, similar to the event scheduler user interface 52, once the user makes selections in the selection fields included in the content transmission user interface 74, the user selects a confirmation button 92 labeled “OK” to confirm the selections or a cancellation button 94 labeled “Cancel” to cancel the selections entered and return to the event scheduler user interface 52.

Returning to FIG. 1, after the user has produced and scheduled the event by appropriately inputting data and selecting settings in the event scheduler user interface 52 (shown in FIG. 2A) and the content transmission user interface 74 (shown in FIG. 2B), the input data and selected settings are transmitted from the web browser 12 to the event scheduler 22. Once received by the event scheduler 22, the data and settings are transferred to the content scheduler 32 that enters the input data and selected settings in an event data (ED) file 34 that is stored on the storage device 26 until the time and date of the scheduled event arrives. For example, data identifying the selected content (e.g., video, audio, data, etc.) and the respective source of the content (e.g., satellite link, phone line, file on a storage device, etc.) are stored in the ED file 34. Additionally, by storing the input data and selected settings in the ED file 34, the information needed to produce and transmit the event from the server 20 to the destination computer systems 28, 30 at the scheduled time is included in the ED file. So by accessing the ED file 34 at scheduled time of an event, all of the information provided by the user through the user interfaces 52, 74 (shown in FIG. 2A and 2B) is efficiently stored at a single location.

Additionally, in some arrangements the ED file 34 includes extensible markup language (XML), wireless markup language (WML), or other similar standard generalized markup language (SGML) for executing the scheduled event. Additionally some ED files 34 include hypertext markup language (HTML) to identify the input data and selected settings. Further, in some arrangements the ED file 34 includes computer code or language used for executing processes associated with the scheduled event. For example, some ED files 34 include computer code that is executed to access a particular content source (e.g., a satellite link, phone line, etc.) and collect the content included in the scheduled event.

Data identifying the scheduled time and date of the event is also included the ED file 34 such that the time and date is accessible by the event scheduler 22 to aide in determining if the event's scheduled time and date has arrived. Alternatively, in some arrangements the data identifying the scheduled time and date of an event is stored in a log file (not shown) with other similar data that identifies other scheduled events so that only the log file is monitored for determining the next scheduled event to execute. After the ED file 34 is produced by the content scheduler 80, the ED file 34 is stored on the storage device 26 (e.g., hard-drive, CD-ROM, etc.) that is in communication with the server 20. However, in some arrangements the ED file 82, along with other ED files associated with other scheduled events, are stored on two or more storage devices that are in communication with the server 20 through the Internet 18 or other similar communication technique.

The event scheduler 22 also includes the event launching process 36 that determines if a scheduled time and date of the event associated with the ED file 34 has arrived. Typically, the event launching process 36 accesses the ED file 34 for scheduled date and time data stored in the file to determine if appropriate to execute the event. Alternatively, the event launching process 36 accesses the log file (not shown) for monitoring the execution time and date of each scheduled event. When the event launching process 36 determines that the appropriate time and date to execute the scheduled event has arrived, the ED file 34 is retrieved from the storage device 26 and executed. By executing the ED file 34, the event content to be transmitted from the server 20 to the computer systems 28, 30 is collected from the respective sources provided by the ED file. For example, if the event being executed from the ED file 34 includes video content from a satellite link, the appropriate satellite link is established with the server 20 and the video content is collected by the event launching process 36. Additionally, if the scheduled event includes data content from a data file (e.g., a PowerPoint™ presentation), the appropriate data file is retrieved from the storage device 26 or other storage device. The ED file 34 also includes data that identifies other files used for executing the scheduled event. For example, the ED file 34 includes data that identifies one or more files that include polling questions, survey questions, response choices, or other data associated with an interactive activity included in the scheduled event.

The ED file 34 also identifies the profile file 38 associated with the scheduled event. In this particular example, the profile file 38 is also stored on the storage device 26, however in some arrangements the profile file 38 is stored on another storage device not storing the ED file 34. In general, the profile file 38 is produced from the profile managing process 40 that is included in the event scheduler 22. The profile file 38 is typically an XML file and includes data associated with the transmission quality selected by the user in the transmission quality selection field 80 (shown in FIG. 2B). For example, if the user selected the broadband selection from the transmission quality selection field 80, the ED file 34 identifies the profile file 38 that includes transmission parameters associated with broadband transmitting of the scheduled event from the server 20 to the destination computer systems 28, 30. In one example, the profile file 38 associated with broadband transmitting includes parameters so that transmitted video content is displayed on a screen size of 320 pixels×240 pixels. Additionally, the profile file 38 includes other transmission parameters for setting the frame rate, identifying the particular one or more encoders to encode the event content, and other parameters associated for broadband transmitting of the scheduled event.

The profile managing process 40 is used by event managing personnel typically located with the server 20 to produce and maintain the profile files 38 used by the event launching process 36. The profile managing process 40 also allows event managing personnel to assist the user in producing and scheduling an event by monitoring and maintaining the profile file 38 such that, for example, as different or improved transmission capabilities are implemented on the server 20 (e.g., adding a faster network interface card, etc.), event managing personnel produce and store a profile file capable of using the different or improved transmission capabilities.

The profile managing process 40 is also used by the event managing personnel to produce one or more option files 42 and to store the option files on the storage device 26 or other similar storage device in communication with the server 20. The option files 42 include data that represents the supported capabilities of the event scheduler 22 that a user selects from to produce and schedule an event. In general the option files 42 identify each potential selection included in the event scheduling user interface 52 (shown in FIG. 2A) and the content transmission user interface 74 (shown in FIG. 2B) along with other user interfaces used to schedule and produce an event. For example, the three selectable encoding formats (e.g., RealMedia™, WindowsMedia™, and QuickTime™) listed in transmission encoding selection field 76 (shown in FIG. 2B) are provided to the content scheduler 32 by the option files 42. By using the option files 42 to store the potential selections for producing and scheduling events, event-managing personnel can control production of the events without actually making the selections to produce and schedule the events. Additionally, similar to the profile files 38, as improvements or changes are implemented in the communication network 10, event-managing personnel edit the option files 42 or produce updated option files to reflect the current capabilities of the communication system. Further, as the communication system 10 is updated with improved equipment (e.g., a faster server, faster network interface cards, etc.), event-managing personnel use the profile managing process 40 to delete outdated option files 42. Additionally, in some arrangements, the event managing personnel use the profile managing process 40 to produce an option file 42 tailored to the needs of a particular user. For example, if a particular user typically produces events for broadband transmission, event-managing personnel produce an option file 42 specifically tailored so only a broadband selection is included in the transmission quality selection field 80 (shown in FIG. 2B). So, by producing the option files 42, which provide the user with the potential selections for producing the ED files 34, the event managing personnel control the production of each scheduled event without actually producing or scheduling each event.

The storage device 26 also stores one or more encoder files 44 that are used by the event launching process 36 to initiate a respective encoding process 46 associated with the encoding format selected by the user in the transmission encoding selection field 76 (shown in FIG. 2B). In general, the encoder file 44 includes instructions and data to execute the encoding process 46. For example, the encoder file 44 includes data that identifies a hardware configuration (e.g., identifies input ports, output ports, etc.) of the server 20 used to receive and transmit event content, identifies reception pathways used to collect the audio and video content (e.g., identifies the pathway for a satellite link, etc.), and identifies other data such as data for locating and accessing the encoding process 46 for encoding the event content. Typically each encoder file 44 is associated with one of the respective encoding formats supported by the event scheduler 22. So the event scheduler 22 includes the encoding process 46 and other encoding processes (not shown) that are associated with the supported encoding formats and the respective encoder files 44 stored on the storage device 26 for executing each encoding process.

The event launching process 36 determines if the scheduled time and date of the event has arrived by monitoring the individual ED files 34 or the log file (not shown) that contains the scheduled time and date for each event associated with an ED file stored on the storage device 26. When determined that the event's scheduled time and date have arrived, the event launching process 36 retrieves the ED file 34 associated with the event to initiate the event. By retrieving and accessing the ED file 34, the event launching process 36 determines which encoder file is needed for executing the appropriate encoding process. In this particular example, the ED file 34 includes data that identifies the encoder file 44, which is retrieved by the event launching process 36 to execute the encoding process 46 for encoding the content of the scheduled event. Additionally, to execute the encoding process 46 the event launching process 36 uses data in the ED file 34 to retrieve the appropriate profile file 38 that provides parameters for executing the encoding process 46.

The event launching process 36 also uses the ED file 34 to identify the particular content and the source of the identified content. In this particular example, the ED file 34 includes data identifying the content selected from the content selection field 60 (shown in FIG. 2A) and the source of each selected content from the content source selection field 64 (also shown in FIG. 2A). The event launching process 36 uses the content and content source data to collect the respective content for encoding and transmitting from the server 20 to the destination computer systems for presenting. For example, video content to be included in the transmitted event is collected from the respective video content source (e.g., satellite link #3) along with the audio content collected from the respective audio content source (e.g., phone number 1-800-555-2141) and the data content collected from the PowerPoint presentation file (e.g., f:\slide.ppt). Additionally, the event launching process 36 determines from the ED file 34 that the scheduled event is an interactive event and retrieves a data file (not shown) that includes questions to be transmitted and presented to the event attendees.

After the event content is retrieved by the event launching process 36, the content is assembled by the content launching process 36 into a data stream for encoding and transmitting. In addition to the collected content, other data is included in the data stream for presenting the event content. For example, to synchronize displaying of each slide included in the PowerPoint™ presentation with the video and audio content, one or more instructions are included in the data stream so that the appropriate slide is displayed with the corresponding video and audio content. In some arrangements an instruction including a timestamp is included in the data stream such that when a particular portion of audio content is played over a speaker respectively connected to each computer system 28, 30 at a particular time, a particular slide included in the PowerPoint™ presentation is displayed on the screen of each computer system 28, 30.

Once the event launching process 36 produces the data stream that includes the event content and other associated data, the data stream is sent to the encoding process 46. The encoding process 46 receives and encodes the data stream with the particular encoding format identified in the ED file 34. In this particular example, the data stream is encoded with the RealMedia™ encoding format based on the user selection in the transmission encoding selection field 76 (shown in FIG. 2B). Typically the data stream is encoded by one encoding process 46 for transmission to both of the destination computer systems 28, 30. However, in some arrangements the data stream is sent to more than one encoding process for encoding in different encoding formats. For example, the data stream is sent to the encoding process 46 for encoding into one encoding format (e.g., RealMedia™) that is supported by destination computer system 28 while also being sent from the event launching process 36 to another encoding process (not shown) for encoding into another encoding format (e.g., WindowsMedia™) that is supported by the other destination computer system 30. After the data stream is encoded by the encoding process 46, the encoded data stream is sent from the event scheduler 22 to the server 20 for transmitting to the destination computer systems 28, 30 that decode and present the event content to the attendees. Additionally, in some arrangements the encoded data stream is stored on the storage device 26, or one or more other storage devices so that the encoded data stream is capable of being retrieved at a later time for re-transmission to the destination computer systems 28, 30 or for transmission to another computer system (e.g., computer system 14) that supports the encoding format of the data stream. So, in some arrangements a scheduled event includes live content, previously recorded content, or a combination of live and previously recorded content.

As the data stream is received and decoded, and the event included in the data stream is presented on the destination computer systems 28, 30. In this particular example interactive material (e.g., polling questions, survey questions, etc.) included in the event is also presented to the attendees. In response to interactive material, the attendees input response data into the respective computer systems 28, 30 and the response data is sent to the server 20 and passed to the interaction process 48 executing in the memory 24 of the server. Also, in some arrangements the executing event is capable of receiving unsolicited feedback (e.g., questions, comments, etc.) from the attendees (e.g., students) for transmission to the content source (e.g., a teacher lecturing over a phone line) in real-time during the event. Besides being sent from the respective computer system 28, 30 to the server 20 and then to the content source, the unsolicited feedback is also sent to the interaction process 48. After the interaction process 48 receives the solicited or unsolicited feedback, the feedback is stored in the response file 50 on the storage device 26, or another similar storage device in communication with the server 20. By storing the responses of a particular event, statistical processes (not shown) can access the response files and process the stored responses for polling and survey results. In some arrangements by storing the responses, the response file 50 is capable of being sent to a sponsor of a particular event for later use of the response data (e.g., sending event related material). Additionally, stored unsolicited feedback is capable of being post-processed to determine problematic areas of a lecture or to expose other similar event artifacts after the scheduled event.

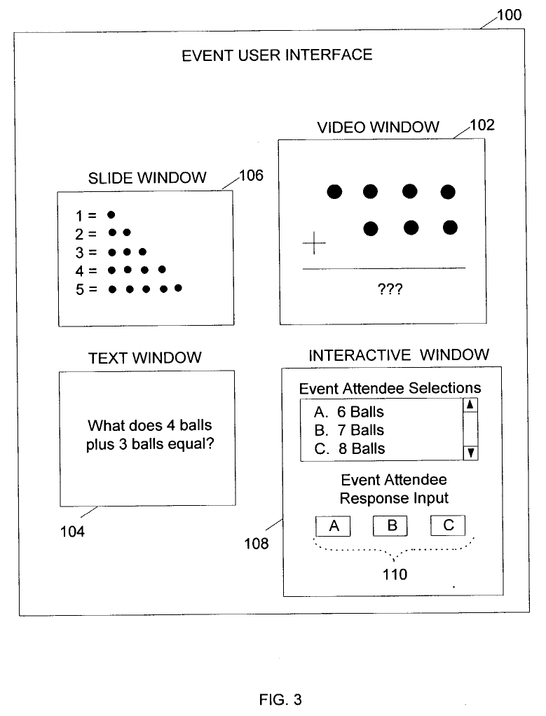

Referring to FIG. 3 a portion of an exemplary event being presented on either of the destination computer systems 28, 30 (shown in FIG. 1) at the event's scheduled time and date is shown. In this particular example the event is displayed in an event presentation user interface 100 that includes content associated with an educational lecture. Video content is displayed to event attendees in a video window 102 included in the event presentation user interface 100. In this particular example, the video content includes graphics presenting a mathematical exercise to the event attendees. The event presentation user interface 100 also includes a text window 104 that presents text from a data file (e.g., an MS-Word™ document) that corresponds to audio content played over one or more speakers connected to the respective computer system 28, 30 (shown in FIG. 1). Additionally, the event presentation user interface 100 includes a slide window 106 for displaying slides from a PowerPoint™ presentation data file included in the event content. In this example, the displayed slide provides background material for the attendees to use in solving the exercise presented in the video window 102 and described in the test window 104. Also in this particular example, since the event was produced with an interactive capability, the event presentation user interface 100 includes an interactive window 108 for the user to provide a response. In this particular example, the interactive window 108 receives a selection from the event attendees based on the question posed by the video content in the video window 102, audibly provide from audio content, and also textually provided in the text window 104. After the event attendees study the mathematical exercise and the potential answers provided by the interactive window 108, in this arrangement the event the attendees indicate a response by selecting from one of three response buttons 110 included in the interactive window 108. Data representing the selection is then transmitted from the respective computer system 28, 30 (shown in FIG. 1) to the interaction process 96 (shown in FIG. 1) executing on the server 20 (shown in FIG. 1) for processing and storing the response.

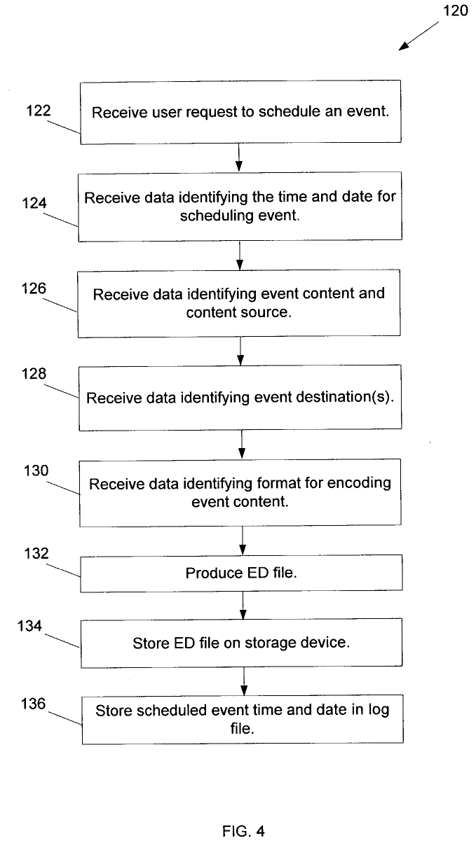

Referring to FIG. 4, an example of the content scheduler 120 includes receiving 122 a user request to schedule an event. In some arrangements a web browser process, such as the web browser 12 (shown in FIG. 1), receives the request from the user and initiates sending the user request to the content scheduler 120. After receiving 122 the request, the content scheduler 120 receives 124 data identifying the particular time and date to schedule the event. Additionally in some arrangements, multiple dates and time are received for scheduling a series of events. After the scheduling data is received 124, the content scheduler 120 receives 126 data identifying content to be included in the scheduled event. For example, video, audio, one or more data files (i.e., a PowerPoint presentation), or other similar content is identified along with the source (e.g., satellite link, phone line, etc.) of the particular content. After receiving 126 the data identifying the content and the source of the content, the content scheduler 120 receives 128 data identifying one or more destination sites (e.g., computer systems 28 and 30 in FIG. 1) for the scheduled event to be presented to one or more attendees. For example, in some arrangements IP addresses for each destination computer system are received by the content scheduler 120. The content scheduler 120 also includes receiving 130 data that identifies the one or more encoding formats (e.g., RealMedia™, WindowsMedia™, QuickTime™, etc.) to encode the content for transmission to the destination computer systems. Typically the encoding format applied to the content depends upon the format supported by the destination computer systems. For example, if one or more of the destination computer systems support the RealMedia™ format, the content scheduler 120 typically receives data identifying that particular format for application to the event content. After receiving 124, 126, 128, 130 the data, the content scheduler 120 produces 132 an ED file that includes data representing the received data and is used to execute the event at the scheduled time and date. In some arrangements the ED file includes XML, HTML, or other similar language for executing the event at the appropriate time and date. After the ED file is produced 132, the content scheduler 120 stores 134 the ED file on a storage device, such as the storage device 26 (shown in FIG. 1) so that the ED file is retrievable at the scheduled time and date of the event. Additionally, in some arrangements the scheduled time and date of the event is stored 136 in a log file that includes a list of other scheduled events along with their respectively scheduled times and dates such that an event launching process can determine if the scheduled time and date of each respective event has arrived.

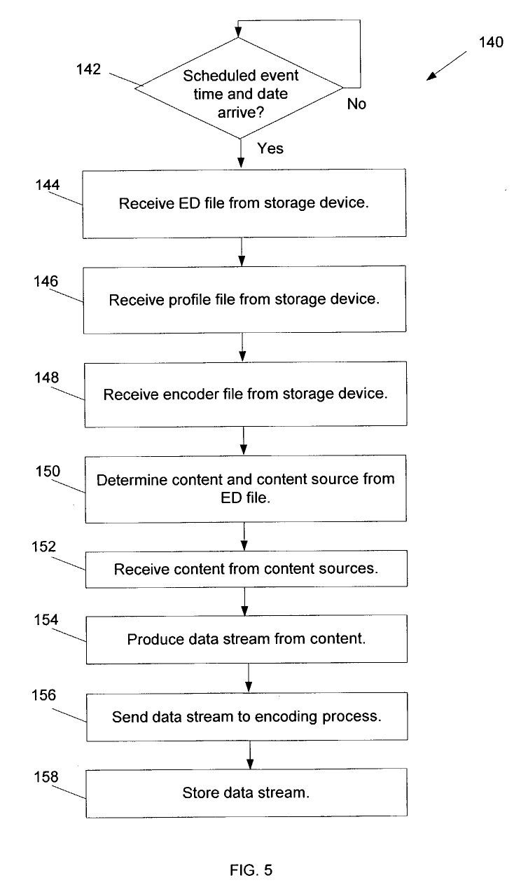

Referring to FIG. 5 event launching process 140 includes determining 142 if the scheduled time and date of an event has arrived. In some arrangements the determination is made by monitoring the log file that includes a list of scheduled events. If determined that the time and date of the scheduled event has arrived, the event launching process 140 retrieves 144 an ED file associated with the scheduled event from a storage device such as the storage device 26 (shown in FIG. 1). Additionally, the event launching process 90 retrieves 146 a profile file from a storage device, such as the storage device 26 (shown in FIG. 1). The profile file includes data associated with transmitting the content of the scheduled event identified in the ED file. For example if the ED file includes data identifying content is transmitted with a broadband transmission quality, a profile file is retrieved that includes broadband transmission parameters (e.g., screen size of 320 pixels×240 pixels, etc.).

The event launching process 140 also includes receiving 148 an encoder file from a storage device, such as storage device 26 (shown in FIG. 1) for invoking an encoding process, such as the encoding process 94 (shown in FIG. 1). After receiving 144 the ED file, the event launching process 140 determines 150 the event content and the one or more sources of the content from the ED file. After determining 150 the content and respective content sources, event launching process 140 receives 152 the content from the content sources and produces 154 a data stream that includes the event content. After producing 154 the data stream, the event launching process 140 sends 156 the data stream to the encoding process for encoding the data stream into a format supported by the destination computer system. Typically after the encoding process encodes the data stream, the encoded data stream is transmitted to the destination computer systems for decoding and presenting the event. Additionally, after producing 154 the data stream the launching process 140 stores 158 the data stream for later accessing and presenting the event content at another time and date.

The processes described herein can be implemented in digital electronic circuitry, or in computer hardware, firmware, software, or in combinations of them. The processes described herein can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Methods can be performed by one or more programmable processors executing a computer program to perform functions of the invention by operating on input data and generating output. The method can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer include a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide interaction with a user, the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The processes described herein can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The processes described herein can also be implemented in other electronic devices individually or in combination with a computer or computer system. For example, the processes can be implemented on mobile devices (e.g., cellular phones, personal digital assistants, etc.).

The invention has been described in terms of particular embodiments. Other embodiments are within the scope of the following claims. For example, the steps of the invention can be performed in a different order and still achieve desirable results.

What is claimed is:

1. A method of scheduling a user-defined event for transmission over a network, the method comprising:
receiving event scheduling data over the network from a user;
receiving event content data over the network from the user;
producing a file that includes data based on the event scheduling data and the event content data; and
storing the file on a storage device for retrieval based on the event scheduling data.

2. The method of claim 1, wherein the event scheduling data includes data representing a time and date for executing the user-defined event.

3. The method of claim 1, wherein the event scheduling data includes data representing a destination for presenting the user-defined event.

4. The method of claim 1, wherein the event content data identifies content included in the event.

5. The method of claim 1, wherein the event content data identifies a content source.

6. The method of claim 1, wherein the event content data identifies video content.

7. The method of claim 1, wherein the event content data identifies interactive content.

8. The method of claim 1, wherein the event content data identifies a data file.

9. The method of claim 1, wherein the event content data identifies a content encoder.

10. The method of claim 1, wherein the event content data identifies a RealMedia encoder.

11. The method of claim 1, wherein the file includes extensible markup language.

12. A process for scheduling a user-defined event for transmission over a network, the process comprising:
a first reception process for receiving event scheduling data over the network from a user;
a second reception process for receiving event content data over the network from the user;
a production process for producing a file that includes data based on the event scheduling data and the event content data; and
a storage process for storing the file on a storage device for retrieval based on the event scheduling data.

13. The process of claim 12, wherein the event scheduling data includes data representing a time and date for executing the user-defined event.

14. The process of claim 12, wherein the event scheduling data includes data representing a destination for presenting the user-defined event.

15. The process of claim 12, wherein the event content data identifies content included in the event.

16. The process of claim 12, wherein the event content data identifies a content source.

17. The process of claim 12, wherein the event content data identifies video content.

18. The process of claim 12, wherein the event content data identifies interactive content.

19. The process of claim 12, wherein the event content data identifies a data file.

20. The process of claim 12, wherein the event content data identifies a content encoder.

21. The process of claim 12, wherein the event content data identifies a RealMedia encoder.

22. The process of claim 12, wherein the file includes extensible markup language.

23. An article comprising a machine-readable medium which stores executable instructions to schedule a user-defined event for transmission over a network, the instructions causing a machine to:
receive event scheduling data over the network from a user;
receive event content data over the network from the user;
produce a file that includes data based on the event scheduling data and the event content data; and
store the file on a storage device for retrieval based on the event scheduling data.

24. The article of claim 23, wherein the event scheduling data includes data representing a time and date for executing the user-defined event.

25. The article of claim 23, wherein the event scheduling data includes data representing a destination for presenting the user-defined event.

26. The article of claim 23, wherein the event content data identifies content included in the event.

27. The article of claim 23, wherein the event content data identifies a content source.

28. The article of claim 23, wherein the event content data identifies video content.

29. The article of claim 23, wherein the event content data identifies interactive content.

30. The article of claim 23, wherein the event content data identifies a data file.

31. The article of claim 23, wherein the event content data identifies a content encoder.

32. The article of claim 23, wherein the event content data identifies a RealMedia encoder.

33. The article of claim 23, wherein the file includes extensible markup language.
